(19) United States
(12) Patent Application Publication
(10) Pub. No.: US 2024/0347815 A1
(43) Pub. Date: Oct. 17, 2024

(54) THERMAL BARRIER FOAM SYSTEMS FOR USE WITHIN TRACTION BATTERY PACKS

(71) Applicant: FORD GLOBAL TECHNOLOGIES, LLC, Dearborn, MI (US)

(72) Inventors: Bhaskara Rao Boddakayala, Troy, MI (US); Kimberley King, Northville, MI (US); Stefan Paul Pototschnik, Canton, MI (US); Jason Luesing, Hazel Park, MI (US); Inderdeep Singh, South Lyon, MI (US); Mladen Marjanovic, Windsor (CA); Daryl Marlow, Dearborn, MI (US); Tyler William Roe, Brownstown, MI (US)

(21) Appl. No.: 18/300,771

(22) Filed: Apr. 14, 2023

(51) Int. Cl. H01M 10/658; H01M 10/625; H01M 10/6557; H01M 50/284; H01M 50/507

(52) U.S. Cl. CPC H01M 10/658; H01M 10/625; H01M 10/6557; H01M 50/284; H01M 50/507; H01M 2220/20

(57) ABSTRACT

Battery thermal barrier foam systems are provided for use within traction battery packs. Exemplary battery thermal barrier foam systems may include one or more foam blocks arranged to fill void spaces within a battery array of a traction battery pack. Each foam block may include a high temperature material system capable of mitigating cell-to-cell and/or array-to-array thermal propagation, increasing thermal insulation between battery cells, absorbing heat, etc.

### TECHNICAL FIELD

This disclosure relates generally to electrified vehicle traction battery packs, and more particularly to thermal barrier foam systems for use within battery arrays of traction battery packs.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a battery array, a void space located within the battery array, and a first foam block arranged to fill the void space.

In a further non-limiting embodiment of the foregoing traction battery pack, the first foam block is arranged to extend between adjacent cell tab terminals of the battery array.

In a further non-limiting embodiment of either of the foregoing traction battery packs, the first foam block is arranged to extend between a cell tab terminal of a battery cell and a side plate of an array housing of the battery array.

In a further non-limiting embodiment of any of the foregoing traction battery packs, the first foam block is arranged to extend between a cell tab terminal of a battery cell and an end plate of an array housing of the battery array.

In a further non-limiting embodiment of any of the foregoing traction battery packs, the first foam block is arranged to extend between a battery cell and a cover of an array housing of the battery array.

In a further non-limiting embodiment of any of the foregoing traction battery packs, the first foam block is arranged to extend between a flexible printed circuit board and a cover of an array housing of the battery array.

In a further non-limiting embodiment of any of the foregoing traction battery packs, the first foam block is arranged to extend between a base and a cover of a bus bar module of the battery array.

In a further non-limiting embodiment of any of the foregoing traction battery packs, the bus bar module is mounted to a side plate of an array housing of the battery array.

In a further non-limiting embodiment of any of the foregoing traction battery packs, the first foam block includes a foam portion and an endothermic aerogel system.

In a further non-limiting embodiment of any of the foregoing traction battery packs, the foam portion includes a polyurethane foam.

In a further non-limiting embodiment of any of the foregoing traction battery packs, the endothermic aerogel system includes an aerogel additive, an intumescent additive, a melamine powder, and an endothermic additive.

A traction battery pack according to another exemplary aspect of the present disclosure includes, among other things, a first battery cell including a first cell tab terminal, a second battery cell including a second cell tab terminal, and a first foam block arranged to fill a space between the first cell tab terminal and the second cell tab terminal.

In a further non-limiting embodiment of the foregoing traction battery pack, the first foam block includes a foam portion and an endothermic aerogel system.

In a further non-limiting embodiment of either of the foregoing traction battery packs, the foam portion includes a polyurethane foam, and the endothermic aerogel system includes an aerogel additive, an intumescent additive, a melamine powder, and an endothermic additive.

In a further non-limiting embodiment of any of the forgoing traction battery packs, a second foam block is arranged to fill a space between the first cell tab terminal or the second cell tab terminal and a side plate of an array housing of a battery array that includes the first battery cell and the second battery cell.

In a further non-limiting embodiment of any of the forgoing traction battery packs, a second foam block is arranged to fill a space between the first cell tab terminal or the second cell tab terminal and an end plate of an array housing of a battery array that includes the first battery cell and the second battery cell.

In a further non-limiting embodiment of any of the forgoing traction battery packs, a second foam block is arranged to extend between the first battery cell or the second battery cell and a cover of an array housing of a battery array that includes the first battery cell and the second battery cell.

In a further non-limiting embodiment of any of the forgoing traction battery packs, a second foam block is arranged to extend between a flexible printed circuit board and a cover of an array housing of a battery array that includes the first battery cell and the second battery cell.

In a further non-limiting embodiment of any of the forgoing traction battery packs, a second foam block is arranged to extend between a base and a cover of a bus bar module of a battery array that includes the first battery cell and the second battery cell.

In a further non-limiting embodiment of any of the forgoing traction battery packs, a second foam block is arranged to fill a space between the first cell tab terminal or the second cell tab terminal and a side plate of an array housing of a battery array that includes the first battery cell and the second battery cell, and a third foam block is arranged to fill a space between the first battery cell or the second battery cell and a cover of the array housing.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is a cross-sectional view of the traction battery pack of FIG. 2.

FIG. 4 is a side perspective view of portions of a battery array of a traction battery pack. The battery array is equipped with a thermal barrier foam system.

FIG. 5 is a blown-up view of portions of the battery array of FIG. 4.

FIG. 6 illustrates a thermal barrier foam system with foam blocks positioned on both sides of a cell stack.

FIG. 7 illustrates a bus bar module of a battery array.

FIG. 8 illustrates a thermal barrier foam system with foam blocks positioned over top of a cell stack.

FIG. 9 illustrates a flexible printed circuit board of a battery array.

FIG. 10 is a cross-sectional view of a battery array.

FIG. 11 schematically illustrates a high temperature material system of a foam block of a thermal barrier foam system.

FIG. 12 schematically illustrates another exemplary high temperature material system of a foam block of a thermal barrier foam system.

### DETAILED DESCRIPTION

This disclosure details exemplary thermal barrier foam systems for use within traction battery packs. Exemplary battery thermal barrier foam systems may include one or more foam blocks arranged to fill void spaces within a battery array of a traction battery pack. Each foam block may include a high temperature material system capable of mitigating cell-to-cell and/or array-to-array thermal propagation, increasing thermal insulation between battery cells, absorbing heat, etc. These and other features are discussed in greater detail in the following paragraphs of this detailed description.

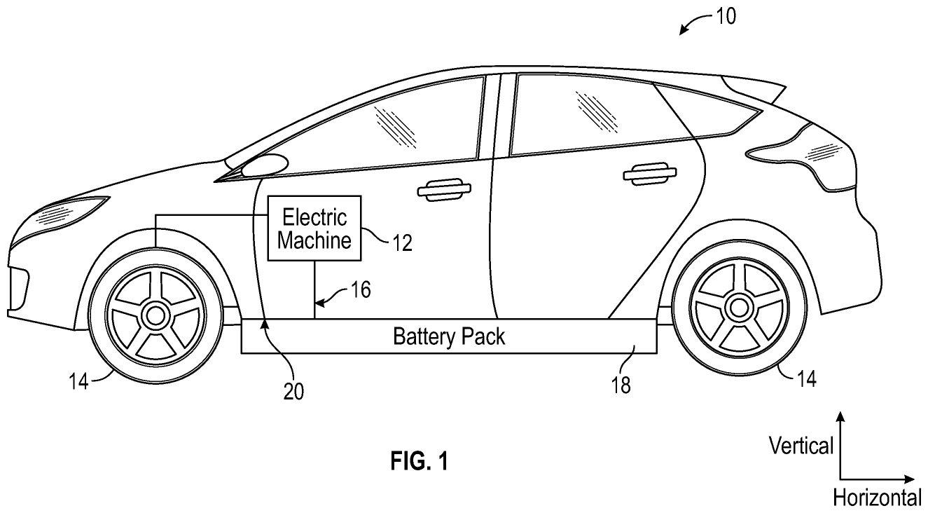

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

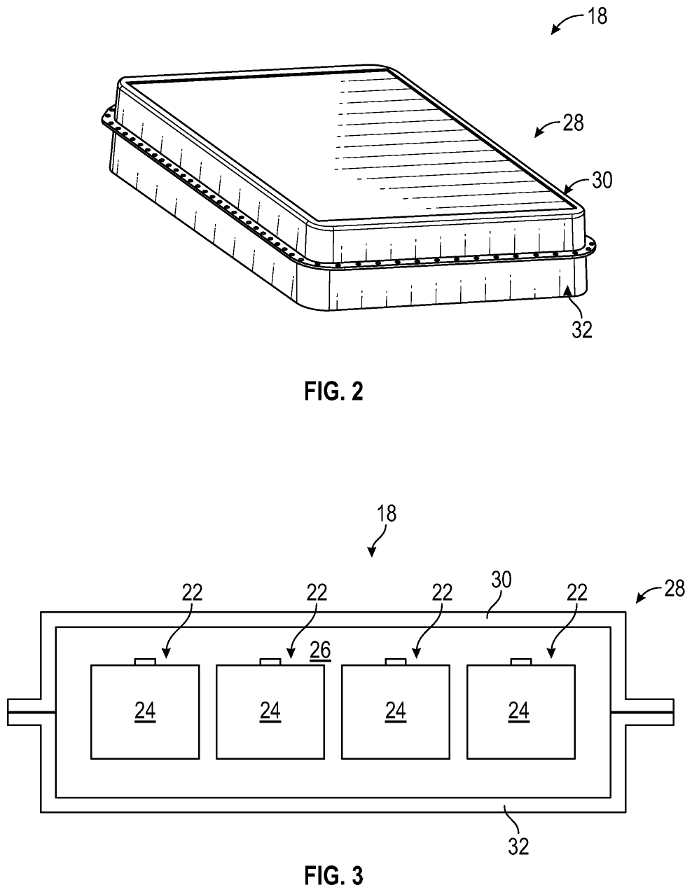

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

From time to time, one or more of the battery cells 24 can experience a relatively rare thermal event in which pressure and thermal energy inside the cell(s) increases. The pressure and thermal energy increase can be due to an overcharge condition, an overdischarging condition, or a short circuit event, for example. A relatively significant amount of heat can be generated during battery thermal events, and this heat can sometimes cascade from cell-to-cell and/or from array-to-array within the traction battery pack 18. This disclosure is therefore directed to thermal suppression foam systems designed for mitigating the effects of battery thermal events.

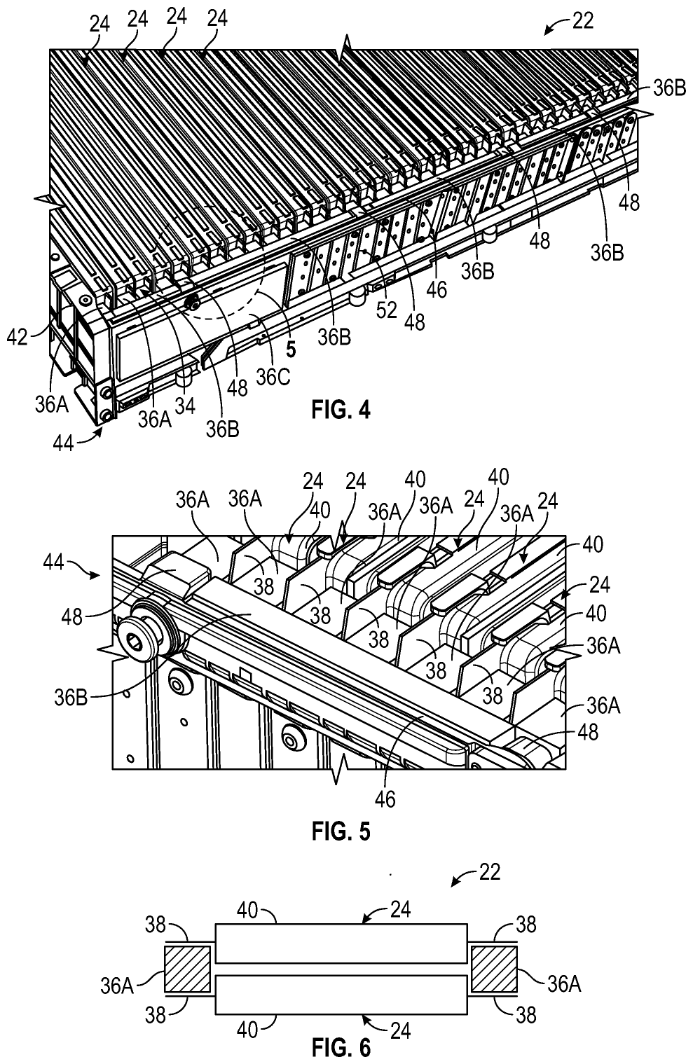

FIGS. 4, 5, and 6 illustrate select portions of a battery array 22 of the traction battery pack 18. The battery array 22 may include a thermal barrier foam system 34 that includes a plurality of foam blocks 36. Unless stated otherwise herein, reference numeral “36” refers to any of the foam blocks 36 when used without any alphabetic identifier immediately following the reference numeral.

The foam blocks 36 of the thermal barrier foam system 34 may be strategically positioned within void spaces found within the battery array 22 for mitigating the effects of battery thermal events. For example, among other benefits, the thermal barrier foam system 34 may be configured to mitigate cell-to-cell and/or array-to-array thermal propagation, increase thermal insulation between the battery cells 24 of the battery array 22, absorb heat, etc.

Each battery cell 24 of the battery array 22 may include a housing 40 and cell tab terminals 38 that project outwardly from the housing 40. In an embodiment, each battery cell 24 includes two cell tab terminals 38, with one cell tab terminal 38 protruding outwardly at each opposing side of the housing 40 (see, e.g., FIG. 6). An aluminum film may provide each housing 40, for example.

A foam block 36A of the thermal barrier foam system 34 may be positioned between cell tab terminals 38 of each adjacent pair of battery cells 24 of the battery array 22. The thermal barrier foam system 34 may therefore include a plurality of the foam blocks 36A. The foam blocks 36A may fill void spaces extending between the cell tab terminals 38 within the battery array 22.

One of the foam blocks 36A may additionally be positioned between cell tab terminals 38 located at the ends of the cell stack and each end plate 42 of an array housing 44 that surrounds the cell stack. The foams blocks 36A may therefore fill void spaces extending between some of the cell tab terminals 38 and the end plates 42 of the array housing 44. In this embodiment, the end plates 42 extend along minor sides of the cell stack.

One or more foam blocks 36B of the thermal barrier foam system 34 may be positioned between the cell tab terminals 38 and each side plate 46 of the array housing 44. In this embodiment, the side plates 46 extend along major sides of the cell stack. The foam blocks 36B may fill void spaces extending between the cell tab terminals 38 and the side plates 46 of the array housing 44. The foam blocks 36B may embody different sizes and may be separated from one another by one or more columns 48 arranged along the lengths of the side plates 46. The columns 48 may be either separate structures or integrated features of the side plates 46.

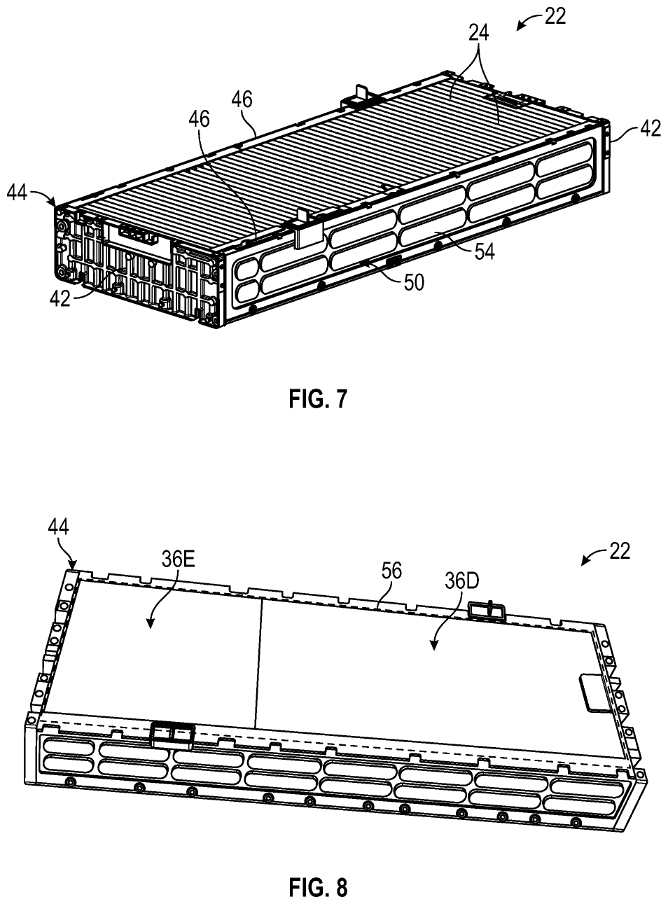

Referring now to FIGS. 4 and 7, the battery array 22 may include a bus bar module 50 for electrically connecting the battery cells 24 of the cell stack. The bus bar module 50 may be mounted to one of the side plates 46 of the array housing 44 on an opposite side of the side plate 46 from the battery cells 24. The bus bar module 50 may include a base 52 (see FIG. 4) and a cover 54 (see FIG. 7) received over the base 52.

One or more foam blocks 36C of the thermal barrier foam system 34 may be positioned between the base 52 and the cover 54 of the bus bar module 50. The foam blocks 36C may fill void spaces extending between the base 52 and the cover 54 of the bus bar module 50.

Referring now to FIGS. 8, 9, and 10, one or more foam blocks 36D of the thermal barrier foam system 34 may be positioned between the battery cells 24 of the cell stack and a cover 56 of the array housing 44. The foam blocks 36D may fill void spaces extending between the battery cells 24 and the cover 56.

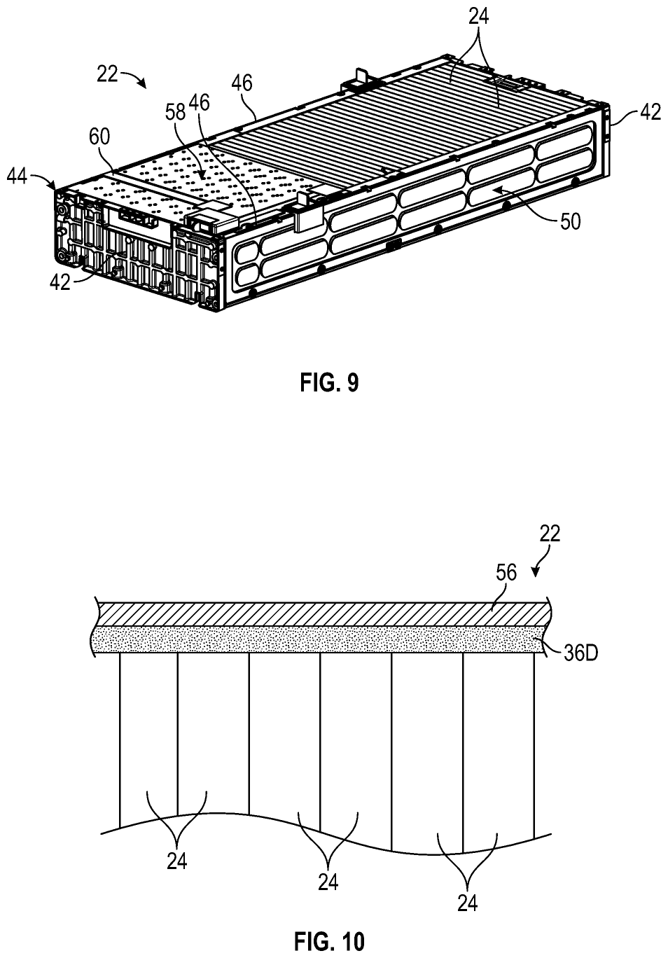

One or more foam blocks 36E of the thermal barrier foam system 34 may additionally be positioned between a flexible printed circuit board 58 (see FIG. 9) of the battery array 22 and the cover 56 of the array housing 44. The flexible printed circuit board 58 may be positioned between the battery cells 24 of the cell stack and the foam block 36E and may include a flexible ribbon cable 60 arranged for monitoring and communicating data (e.g., temperate, voltage, current, state of charge, etc.) associated with the battery cells 24. The foam block 36E may fill void spaces between the flexible printed circuit board 58 and the cover 56 of the array housing 44.

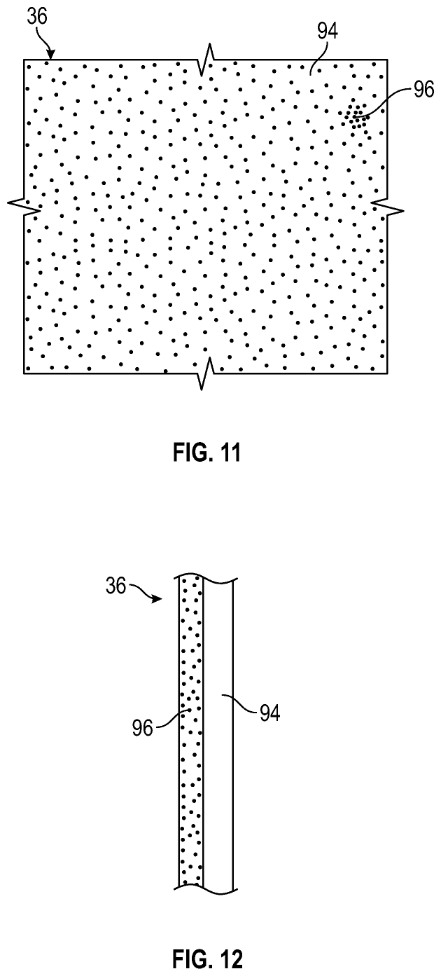

Each foam block 36 of the thermal barrier foam system 34 may be made of a high temperature material system that includes a foam portion 94 and an endothermic aerogel system 96. In an embodiment, the foam portion 94 may be impregnated with the endothermic aerogel system 96 (see FIG. 11). In another embodiment, the endothermic aerogel system 96 may be configured as a sheet-like structure that can be adhered or otherwise secured to the foam portion 94 (see FIG. 12).

The foam portion 94 may include a polyurethane foam. However, other foam materials or combinations of materials could alternatively or additionally be utilized within the scope of this disclosure.

The endothermic aerogel system 96 may include a non-woven ceramic fiber that includes various integrated fillers. In an embodiment, the endothermic aerogel system 96 includes aerogel additives (about 1-2%), intumescent additives (about 1.0-1.5%), melamine powder (about 0.5-1.2%), and endothermic additives (about 1-1.2%), with each substituent component defined as a percentage by weight relative to the total weight of the formulation. However, other formulations are contemplated within the scope of this disclosure. Furthermore, in this disclosure, the term “about” means that the expressed quantities or ranges need not be exact but may be approximated and/or larger or smaller, reflecting acceptable tolerances, conversion factors, measurement error, etc.

In an embodiment, the aerogel additives may include silica or metal oxides, the intumescent additives may include expandable graphene or mono ammonium phosphate, and the endothermic additives may include aluminum trihydrate or sodium silicate. However, other materials or combinations of materials may be utilized within the endothermic aerogel system 96 within the scope of this disclosure.

The endothermic aerogel system 96 may be configured to withstand relatively high temperatures that can develop within the battery array 22, such as during a battery thermal event. For example, the material system may be configured to withstand temperatures of about 700°-800° C. for a continuous exposure of about 5 minutes. The endothermic aerogel system 96 may be further configured to withstand temperatures of up to about 1000° C. for a short duration (e.g., less than about 40 seconds).

The endothermic aerogel system 96 may be further configured to expand during a battery thermal event. For example, when the temperature inside the battery array 22 exceeds a predefined temperature threshold (e.g., between about 120° C. and about 200° C.), the endothermic aerogel system 96 may expand in order to absorb heat and withstand high velocity gas particles, thereby preserving the structural integrity of the battery array 22 and in particular the array housing 44 of the battery array.

The exemplary thermal barrier foam systems of this disclosure are designed to incorporate endothermic aerogel systems for mitigating the effects of battery thermal events within a battery array of a traction battery pack. The systems may provide numerous advantages over known solutions, including but not limited to presenting a novel configuration that significantly slows or even prevents the cell-to-cell transfer of the battery thermal event across the array.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array;
a void space located within the battery array; and
a first foam block arranged to fill the void space.

2. The traction battery pack as recited in claim 1, wherein the first foam block is arranged to extend between adjacent cell tab terminals of the battery array.

3. The traction battery pack as recited in claim 1, wherein the first foam block is arranged to extend between a cell tab terminal of a battery cell and a side plate of an array housing of the battery array.

4. The traction battery pack as recited in claim 1, wherein the first foam block is arranged to extend between a cell tab terminal of a battery cell and an end plate of an array housing of the battery array.

5. The traction battery pack as recited in claim 1, wherein the first foam block is arranged to extend between a battery cell and a cover of an array housing of the battery array.

6. The traction battery pack as recited in claim 1, wherein the first foam block is arranged to extend between a flexible printed circuit board and a cover of an array housing of the battery array.

7. The traction battery pack as recited in claim 1, wherein the first foam block is arranged to extend between a base and a cover of a bus bar module of the battery array.

8. The traction battery pack as recited in claim 7, wherein the bus bar module is mounted to a side plate of an array housing of the battery array.

9. The traction battery pack as recited in claim 1, wherein the first foam block includes a foam portion and an endothermic aerogel system.

10. The traction battery pack as recited in claim 9, wherein the foam portion includes a polyurethane foam.

11. The traction battery pack as recited in claim 9, wherein the endothermic aerogel system includes an aerogel additive, an intumescent additive, a melamine powder, and an endothermic additive.

12. A traction battery pack, comprising:
a first battery cell including a first cell tab terminal;
a second battery cell including a second cell tab terminal; and
a first foam block arranged to fill a space between the first cell tab terminal and the second cell tab terminal.

13. The traction battery pack as recited in claim 12, wherein the first foam block includes a foam portion and an endothermic aerogel system.

14. The traction battery pack as recited in claim 13, wherein the foam portion includes a polyurethane foam, and the endothermic aerogel system includes an aerogel additive, an intumescent additive, a melamine powder, and an endothermic additive.

15. The traction battery pack as recited in claim 12, comprising a second foam block arranged to fill a space between the first cell tab terminal or the second cell tab terminal and a side plate of an array housing of a battery array that includes the first battery cell and the second battery cell.

16. The traction battery pack as recited in claim 12, comprising a second foam block arranged to fill a space between the first cell tab terminal or the second cell tab terminal and an end plate of an array housing of a battery array that includes the first battery cell and the second battery cell.

17. The traction battery pack as recited in claim 12, comprising a second foam block arranged to extend between the first battery cell or the second battery cell and a cover of an array housing of a battery array that includes the first battery cell and the second battery cell.

18. The traction battery pack as recited in claim 12, comprising a second foam block arranged to extend between a flexible printed circuit board and a cover of an array housing of a battery array that includes the first battery cell and the second battery cell.

19. The traction battery pack as recited in claim 12, comprising a second foam block arranged to extend between a base and a cover of a bus bar module of a battery array that includes the first battery cell and the second battery cell.

20. The traction battery pack as recited in claim 12, comprising a second foam block arranged to fill a space between the first cell tab terminal or the second cell tab terminal and a side plate of an array housing of a battery array that includes the first battery cell and the second battery cell, and a third foam block arranged to fill a space between the first battery cell or the second battery cell and a cover of the array housing.
